(19) United States
(12) Patent Application Publication
(10) Pub. No.: US 2003/0080972 A1
(43) Pub. Date: May 1, 2003

(54) Electronic device

(76) Inventor: Robert Gerstner, Augsburg (DE)

Correspondence Address: Neifeld IP Law, P.C., Crystal Plaza 1, Suite 1001, 2001 Jefferson Davis Highway, Arlington, VA, 22202, US

(21) Appl. No.: 10/255,612

(22) Filed: Sep. 27, 2002

(30) Foreign Application Priority Data
Oct. 31, 2001 (DE) DE 10153614.3-53

(51) Int. Cl. G09G 5/00

(52) U.S. Cl. 345/619

(57) ABSTRACT

The invention pertains to an electronic device with a graphic surface, such as a display, on which image contents of programs are displayed in windows. If the image content is too large for the window of the application program, scroll bars are arranged on the side of the window.

According to the invention, the device can be switched to a mode which allows for any movable image content in a window to be grabbed and moved with a pointer device.

The invention pertains to an electronic device with a graphic surface on which displayed image contents are movable.

Especially with regards to portable devices such as notebooks, organizers, and cell phones, the challenge arises to design the device as small as possible, but at the same time to be able to visualize as much information as possible. The dimensions of these devices are set, and the size of the display as well as the resolution is derived from these dimensions. As a result, certain contents, such as Internet pages, often cannot be displayed in their entirety. In this case, in operating systems with a graphic surface, so-called scroll bars on the side of the application window indicate that only a part of the entire content is displayed in the window. At the same time, these scroll bars serve to let the user choose the visible section.

This disadvantage occurs especially in small devices such as notebooks, handhelds, organizers, or so-called smart phones.

Another disadvantage of scroll bars is that they only allow for movement in one direction, that is, horizontal or vertical, and that the user has to get to the desired content section by alternately scrolling vertically and horizontally.

Certain programs allow the user to operate the scroll bars with the directional keys, i.e. the cursor or the page-up and page-down keys. However, the exact functioning depends on the application in use, and moving the scroll bars with the directional keys will only be possible in applications providing this function.

In addition to this, the stride with which the scroll bars can be moved is set. The user cannot choose between an exact, but slow, or a rough, fast movement of the visible area.

Diagonal movement is also limited. If diagonal movement is possible at all, the user in any case cannot determine the exact direction.

According to the current state of technology, software upgrades by some manufacturers of computer mice are known that offer functions such as auto-scrolling. This software enables the user to use the mouse to determine a direction, in which the image content will automatically be moved. The window content to be moved is selected with a mouse click. This point serves as a reference point for the auto-scrolling function. The direction and the speed for the movement of the window content are set by removing the mouse from this point of reference.

This function has the disadvantage that it is easy to overshoot one's goal. The following attempt to correct the selection often results in disorientation.

Another solution to the problem of not being able to display the entire image content in one window is to simply reduce the content in size. This however has the disadvantage that details are lost and text and graphics for example are hard to make out.

Acrobat Reader 4.0, for instance, shows an alternative method for moving the content of a window. As an alternative to scroll bars, a point can be fixed with the mouse button, and the entire image content can be moved by moving the mouse. The mouse button hereby needs to be held down.

This method of moving an image content would also work well in small electronic devices, such as notebooks, organizers and handhelds.

As is the case with all other above-mentioned methods for moving the image content of a window, these functions are always set in the application programs.

This invention is therefore based on the task to further develop the electronic device of this type in a way that a simple movement of the image content is possible even in applications that do not allow for movement of the image content by means of fixing and moving with the mouse button held down.

According to the invention, this task is achieved with the option to switch the device to a mode in which all image contents that can be displayed and moved in the device display are movable in any direction with the help of a pointer instrument.

The electronic device can therefore be switched to a mode in which independent of the application, all image contents can be moved by means of a mouse, a trackball or a pen.

According to a favorable embodiment, the ability to move the image content is achieved by means of a pointer instrument and additional software.

The use of additional software has the advantage that it can be used on any PC, handheld, notebook, etc., and that it can therefore also be used for application programs such as Windows programs.

Favorably, the additional software is selected in a way that the user programs on the electronic device will not be altered.

The switching can be triggered by means of either a soft- or a hardware button. The switching is inasmuch important, as in some programs, such as Word, the mouse is used in the same way for marking a section of the text, as it is used for moving the image content. Thus, in the mode that allows for the image to be moved, the image would be moved around every time the user wanted to mark a portion of the text. For this purpose, the user can simply switch to the original operating mode with the soft- or hardware button.

Below, the invention is explained further based on the embodiment shown in the drawings.

The drawings show:

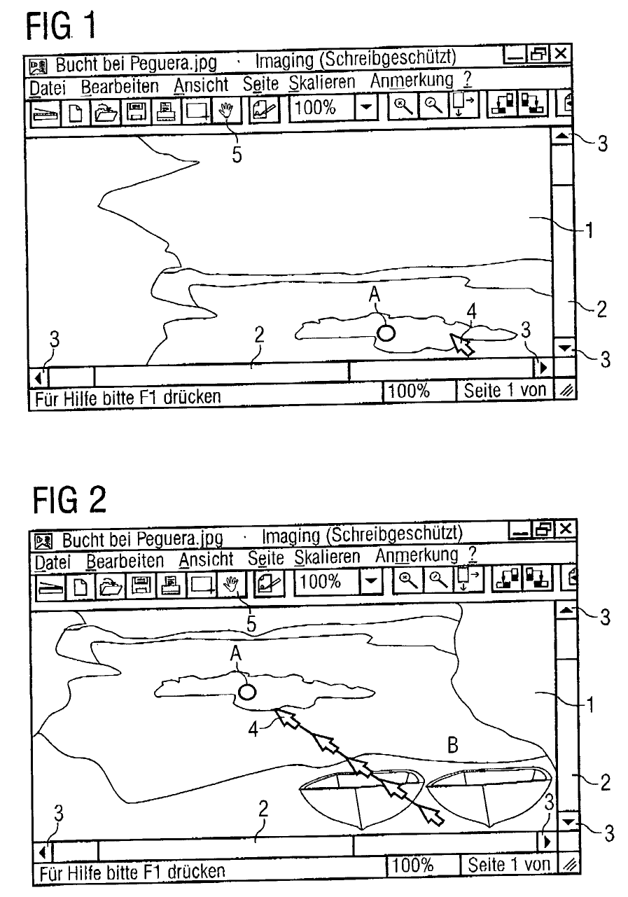

in FIG. 1: a window with scroll bars arranged on the sides, and

in FIG. 2: movement of the image content within the window by means of a mouse.

FIG. 1 shows a window of a Windows-application with scroll bars 2 arranged sideways. The image content 3 can be moved with the scroll bars 2 by clicking on the scroll bars with the mouse, holding down the mouse button, and moving the scroll ball up or down with the mouse. The scroll bars can also be moved by moving the mouse pointer on the arrow buttons 3 and clicking on them with the mouse button.

If the user wants to move the image content directly with the mouse pointer 4 instead of with the scroll bars 2, the user has to use a software button 5, which is integrated into the menu bar, in order to switch to the mode allowing for all image contents in the window to be moved with a pointer instrument.

As shown in FIG. 1, the user now clicks on object A in the image with the mouse pointer 4 and moves object A, as illustrated in FIG. 2, until the desired object B for example appears in the frame.

The movement is accomplished by moving the mouse and holding the mouse button down throughout.

This function for the above-mentioned embodiment can be achieved with additional software, so that the content of any window equipped with scroll bars can simply be moved by means of a pointer device, such as a mouse, a data entry pen, or a trackball.

The additional software has the advantage that all applications can use this function of the additional software without the need to change the applications.

The additional software is either activated with a software button 5, as shown in FIG. 1, or for instance with a hardware button. Pressing the Alt key on a PC keyboard and additionally pressing another special button on the device could for example do the hardware switching.

In the operating mode made possible by the additional software, the user can practically grab the window content and move it to any location by clicking the mouse button, or in case of a touch screen by touching with the pen. When the pointer instrument is moved, the software follows every move and at the same time adjusts the scroll bars of the window, so that the window content follows the pointer instrument. The pointer instrument thus always points at the same point on the window content, and the window content follows the movement of the pointer instrument.

Another embodiment is the use of Internet Explorer on a pocket PC.

Since the content of most web pages is optimized for a resolution of 800×600 or even 1024×768 pixels, usually only a section can be displayed on a pocket PC (resolution 240×320). In order to move the hidden sections into the display, the user employs the usual scroll bars on the side of the application window or the directional keys. The herein described function allows for a considerably easier and more intuitive selection of the displayed section. The function for moving the window content with a pointer device can for instance be activated by means of a push-button. When touching the touch screen with the pointer device or pen, the electronic device, by means of additional, software, designates this point where the pen touches the touch screen as a fixed reference point within the window content. When the pen is moved, the software changes the Internet Explorer scroll bars in a way that the tip of the pen always points at this fixed point, thereby always pointing at the same point within the window content. This neither requires a change to the application (Internet Explorer). The additional software takes over control of the scroll bars and thereby makes this user-friendly function possible.

1. Electronic device with a graphic surface on which the displayed image content is movable, characte riz ed by the fact that the device can be switched to a mode in which all image contents that are movable and can be displayed on the device can be moved in any direction by means of a pointer device.

2. Electronic device according to claim 1, characte riz ed by the fact th at moving the image content is achieved by fixing a point in the image with the pointer device and moving the pointer device.

3. Electronic device according to claims I or 2, characteriz ed by the fact that the ability to move the image contents is achieved by means of a pointer device and additional software.

4. Electronic device according to claim 3, characte riz ed by the fact th at the additional software does not require any adjustment of the user programs on the electronic device.

5. Electronic device according to claim 1, characte riz ed by the fact th at the switching is activated by a software- and/or a hardware button.
